(19) United States
(12) Patent Application Publication
(10) Pub. No.: US 2013/0192313 A1
(43) Pub. Date: Aug. 1, 2013

(54) POWER SHUT-OFF AND SEALING DEVICE

(71) Applicants: Serghei CERBARI, Chisinau (MD); Alexandr LUBENSCHII, Chisinau (MD)

(72) Inventors: Serghei CERBARI, Chisinau (MD); Alexandr LUBENSCHII, Chisinau (MD)

(21) Appl. No.: 13/753,406

(22) Filed: Jan. 29, 2013

(30) Foreign Application Priority Data
Feb. 1, 2012 (MD) MD S 2012 0023

(51) Int. Cl. E05B 63/00

(52) U.S. Cl. CPC E05B 63/00
USPC 70/15

(57) ABSTRACT

A power shut-off and sealing device comprising a metal body, inside which is made a longitudinal blind hole, in which is rigidly fixed one end of a cable, a longitudinal through hole for placement of the locking segment of the cable, the longitudinal blind and through holes being made parallel to each other, a cable locking device, made in the form of two spring-loaded balls and located in the inner cavity of the body, characterized in that in the inner cavity of the body, formed by stamping out a solid metal sheet, is placed a shut-off mechanism, comprising three spring-loaded balls, interacting with the cable upon locking and located between a three-leafed washer and a separator, pushed from above by a spring, and the lower part of the inner cavity of the body is slightly convergent.

The invention relates to devices for locking and concomitant sealing of material objects in order to prevent unauthorized access to them, in particular, doors of covered wagons, tank hatches, steering wheels of hoppers, refrigerator vans, as well as containers and goods transported by railcars and other rolling stocks, equipped with locking means.

It is known a shut-off and sealing device, made as a one-piece seal, containing a metal body, wherein is made a longitudinal blind hole, wherein is rigidly fixed one end of a cable, a longitudinal through hole for placement therein of the cable working segment, the longitudinal blind and through holes being made parallel to each other, two lock members, made in the form of spring-loaded balls of different diameter, located in the inner cavity of the body and interacting with the cable [1].

The known device does not have sufficiently high reliability to criminal breaking This is due to the fact that the interaction of the cable working segment in the locked state with the lock members occurs through a single contact plane. Thus, between the rigidly fixed end of the cable and its free end in the locked state is formed the cable loop, and upon application of the tensile force is possible both cable slipping and turning relative to the spring-loaded lock members and axial movement of the rigidly fixed end. This can cause the criminal breaking of the seal and its re-lock without the discovery of the fact of criminal breaking

The technical result of the proposed invention is to increase the reliability of the device with respect to criminal breaking, combined with the simplicity of design, ease of manufacture, lower-limit dimensions and low cost of manufacturing, providing for its widespread use.

The indicated technical result is achieved by the fact that the proposed power shut-off and sealing device consists of a metal body, which is formed by stamping out a solid metal sheet, inside which is rigidly fixed one end of a cable, by means of deformation of the locking sleeve in the point of its placement in a longitudinal blind hole, a working segment of the cable, a longitudinal through hole placed in the opposite side of the body parallel to the sleeve, through which is passed the working segment of the cable for locking in a shut-off mechanism, the longitudinal blind and through holes being made parallel to each other. In the inner cavity of the body is located a shut-off mechanism, containing three spring-loaded balls, interacting with the cable upon locking and located between a three-leafed washer and a separator, pushed from above by a spring.

Placement of the spring-loaded balls between the three-leafed washer and the separator enables their retention in the plane perpendicular to the working segment of the cable, as well as a more uniform distribution of the load exercised by the spring to all three points of contact of the balls with the cable upon attempted criminal breaking

The lower part of the inner cavity of the body, wherein is placed the shut-off mechanism, is slightly convergent allowing to increase the section through which the cable passes, as well as to increase the pressure of the spring-loaded balls on the working segment of the cable upon attempted criminal breaking thereof.

The balls, locking the cable under the action of the spring, are made of strong steel, all balls having the same diameter and being radially located at an angle of 120° in the plane perpendicular to the working segment of the cable in the locking section. One end of the cable is fixed rigidly in the body by means of deformation of the locking sleeve in the point of its placement in the blind hole. For locking the body of the device is provided a cover, and then the design is assembled by rolling into a rigid solid-metal device. The rigid design of the device is closed from the outside with a protective impact-resistant plastic shell.

The design of the mentioned shut-off mechanism provides effective fastening of the cable because, upon attempt of unauthorized opening, the fixed cable rotates together with the balls impeding both turning and unscrewing and axial displacement of the cable relative to the balls.

Thus, the proposed shut-off and sealing device is made solid-metal, and the presence of the plastic shell ensures leaving traces upon attempted unauthorized breaking, is an element of protection against possible seal breakage by freezing method, allows the implantation of electronic chips reliably protecting them from physical impact, making it more convenient to use and allows to apply on the outer plane surfaces of the body the necessary sealed information.

Summary of the invention is illustrated by the following drawings, wherein:

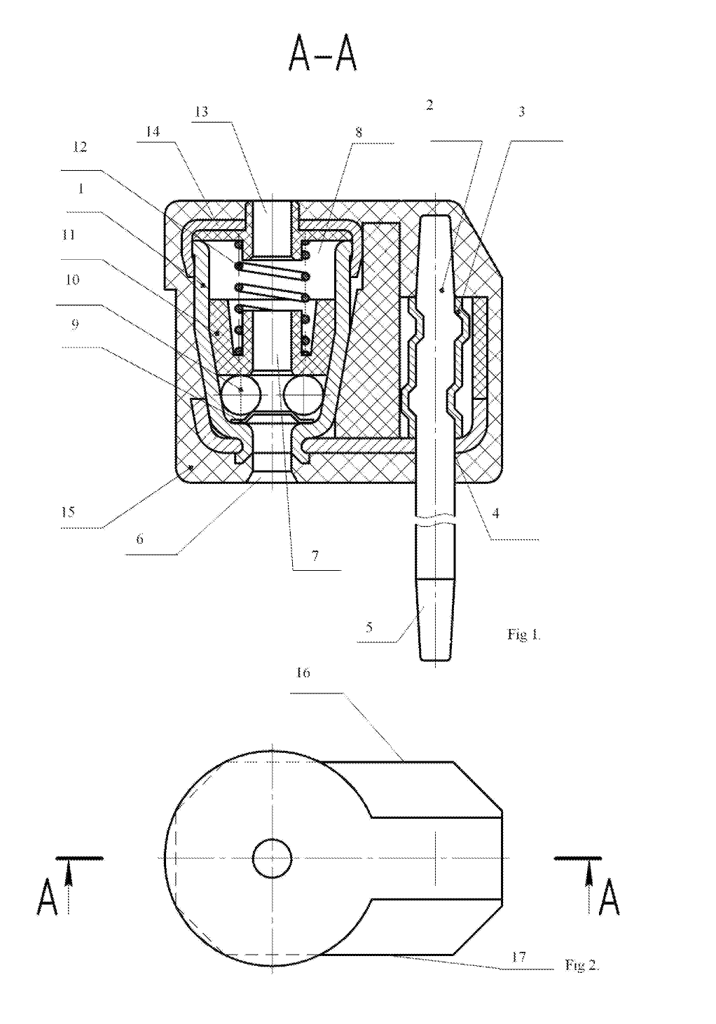

FIG. 1 is a general view of power shut-off and sealing device “TITAN”;

FIG. 2 is an A-A view of FIG. 1.

The power shut-off and sealing device consists of a metal body 1, which is formed by stamping out a solid metal sheet, inside which is rigidly fixed one end of the cable 2, by means of deformation of the locking sleeve 3 in the point of its placement in the longitudinal blind hole 4, a working segment of the cable 5, a longitudinal through hole 7 placed in the opposite side of the body 1 parallel to the sleeve 3, through which is passed the free end of the cable 5 for locking in a shut-off mechanism. In the inner cavity 8 of the body is located the shut-off mechanism, containing spring-loaded lock members, made in the form of three steel balls 10, interacting with the working segment of the cable 5 upon locking and located between a three-leafed washer 9 and a separator 11, pushed from above by a spring 12.

Placement of the spring-loaded steel balls 10 between the three-leafed washer 9 and the separator 11 enables their retention in the plane perpendicular to the working segment of the cable 5, their simultaneous interaction with the cable, as well as a more uniform distribution of the load exercised by the spring 12 to all three points of contact of the balls with the cable.

The lower part of the inner cavity 8 of the body 1, wherein is placed the shut-off mechanism, is slightly convergent allowing to increase the section through which the cable 5 passes, as well as to increase the pressure of the balls on the working segment of the cable 5 upon attempted criminal breaking thereof.

The balls 10, locking the cable 5 under the action of the spring 12, are made of strong steel, all balls having the same diameter and being radially located at an angle of 120° in the plane perpendicular to the working segment of the cable 5 in the locking section. One end of the metal cable 2 is fixed rigidly in the body 1 by means of deformation of the locking sleeve 3 in the point of its placement in the longitudinal blind hole 4. The dimensions of the inlet 6 of the through hole 7 are made with a minimum gap relative to the cable 5. For locking, the body of the device is provided from above with a cover 14, and then the design is assembled by rolling into a rigid solid-metal device. The rigid design of the device is closed with a protective impact-resistant plastic shell 15. The design of the mentioned shut-off mechanism provides the effective fastening of the cable, because upon attempted unauthorized breaking, the working segment of the fixed cable 5 rotates together with the balls 10, impeding both turning and unscrewing and axial displacement of the cable 5 relative to the balls 10.

The proposed power shut-off and sealing device is used as follows. After applying on the outer surfaces 16, 17 of the plastic shell the necessary sealed information, upon locking and sealing the free end of the cable 5 is passed through the lugs of the sealable object, then through the inlet 6 in the longitudinal through hole 7, at the same time the working segment of the cable 5 begins to interact with the spring-loaded balls 10, compressing the spring 12 and moving radially, thus providing for the free movement of the cable 5 to the outlet 13 of the longitudinal through hole 7 up to tightening of the loop around the lugs of the sealable object.

When trying to forcedly remove the cable 5 from the longitudinal through hole 7 of the body 1, the balls 10 begin to interact simultaneously with the working segment of the cable 5, preventing its removal from the body due to the total action of the tensile force of the spring and friction forces.

Thus, the use of the shut-off mechanism in the form of three spring-loaded balls in combination with the plastic shell permitted to create the power shut-off and sealing device “TITAN” characterized by high mechanical strength to withstand loads up to 18 kg and increased resistance to criminal breaking

Thus, the proposed design of the power shut-off and sealing device according to the invention in the given combination of features is characterized, in comparison with the known solutions, by simplicity, high reliability and ease of use.

### BIBLIOGRAPHIC DATA

1. RU 2175707 C1

What is claimed is:

1. A power shut-off and sealing device comprising a metal body, inside which is made a longitudinal blind hole, in which is rigidly fixed one end of a cable, a longitudinal through hole for placement of the locking segment of the cable, the longitudinal blind and through holes being made parallel to each other, a cable locking device, made in the form of two spring-loaded balls and located in the inner cavity of the body, characterized in that in the inner cavity of the body, formed by stamping out a solid metal sheet, is placed a shut-off mechanism, comprising three spring-loaded balls, interacting with the cable upon locking and located between a three-leafed washer and a separator, pushed from above by a spring, and the lower part of the inner cavity of the body is slightly convergent.

2. A power shut-off and sealing device set forth in claim 1, wherein the spring-loaded balls, locking the cable, are made of the same diameter and radially placed at an angle of 120° in the plane perpendicular to the working segment of the cable in the locking section.

3. A power shut-off and sealing device set forth in claim 1, wherein one end of the cable is rigidly fixed in the body by means of deformation of the locking sleeve in the point of its placement in the blind hole.

4. A power shut-off and sealing device set forth in claim 1, wherein the body is coated from the outside with a protective impact-resistant plastic shell providing uninflammability and minimal thermal conductance.
